(19) United States
(12) Patent Application Publication
(10) Pub. No.: US 2009/0151809 A1
(43) Pub. Date: Jun. 18, 2009

(54) METHOD FOR FILLING GASEOUS HYDROGEN STORAGE TANKS

(75) Inventors: Bhaskar Balasubramanian, Houston, TX (US); Lori Ann Long, Houston, TX (US); William Spencer Wheat, Missouri City, TX (US)

Correspondence Address: CHEVRON SERVICES COMPANY;LAW, INTELLECTUAL PROPERTY GROUP, P.O. BOX 4368, HOUSTON, TX, 77210-4368, US

(73) Assignee: Texaco Inc., Sam Ramon, CA (US)

(21) Appl. No.: 11/956,425

(22) Filed: Dec. 14, 2007

(51) Int. Cl. F17C 5/06

(52) U.S. Cl. 141/3

(57) ABSTRACT

The present invention discloses methods for filling gaseous hydrogen storage tanks. The methods of the present invention include methods for refilling gaseous hydrogen storage tanks utilizing a cascade fill. The methods of the present invention provide for the efficient refilling of the gaseous hydrogen storage tanks and the efficient dispensing of gaseous hydrogen to hydrogen vehicles.

### FIELD OF THE INVENTION

The present invention relates generally to a method for filling gaseous hydrogen storage tanks and in particular to a method for refilling gaseous hydrogen storage tanks utilizing a cascade fill.

### BACKGROUND OF THE INVENTION

Hydrogen is utilized in a wide variety of industries ranging from aerospace to food production to oil and gas production and refining. Hydrogen is used in these industries as a propellant, an atmosphere, a carrier gas, a diluents gas, a fuel component for combustion reactions, a fuel for fuel cells, as well as a reducing agent in numerous chemical reactions and processes. In addition, hydrogen is being considered as an alternative fuel for power generation because it is renewable, abundant, efficient, and unlike other alternatives, produces zero emissions. While there is wide-spread consumption of hydrogen and great potential for even more, a disadvantage which inhibits further increases in hydrogen consumption is the absence of a hydrogen infrastructure to provide widespread generation, storage and distribution.

One way to overcome this difficulty is through the operation of hydrogen energy stations. At hydrogen energy stations, reformers are used to convert hydrocarbons to a hydrogen rich gas stream. Hydrocarbon-based fuels, such as natural gas, LPG, gasoline, and diesel, require conversion processes to be used as fuel sources for most fuel cells. Current art uses multi-step processes combining an initial conversion process with several clean-up processes. The initial process is most often steam reforming (SR), autothermal reforming (ATR), catalytic partial oxidation (CPOX), or non-catalytic partial oxidation (POX), or combinations thereof. The clean-up processes are usually comprised of a combination of desulphurization, high temperature water-gas shift, low temperature water-gas shift, selective CO oxidation, selective CO methanation or combinations thereof. Alternative processes for recovering a purified hydrogen-rich reformate include the use of hydrogen selective membrane reactors and filters.

The gaseous hydrogen is then stored in stationary storage tanks at the hydrogen energy stations to provide inventory to fuel hydrogen vehicles. Station operators must be able to efficiently manage the hydrogen inventory at the hydrogen energy station and efficiently dispense the gaseous hydrogen to hydrogen vehicles.

The present invention addresses the management of hydrogen inventory and the dispensing of gaseous hydrogen to hydrogen vehicles by providing a method for refilling gaseous hydrogen storage tanks utilizing a cascade fill.

### SUMMARY OF THE INVENTION

In the present invention, methods for filling gaseous hydrogen storage tanks are disclosed. The methods of the present invention utilize a cascade fill to maintain the fill and the storage distribution of the gaseous hydrogen storage tanks.

A hydrogen energy station stores gaseous hydrogen in stationary storage tanks to provide inventory to fuel hydrogen vehicles. One embodiment of a hydrogen energy station utilizes a cascade storage system for the stationary storage tanks and includes a plurality of stationary storage tanks of varying sizes. After gaseous hydrogen is dispensed to a hydrogen vehicle, the gaseous hydrogen storage tanks need to be refilled back to their original capacity. The methods of the present invention use the different pressure ranges of the different size tanks to refill the gaseous hydrogen storage tanks. The tanks at higher pressures are used to refill the tanks at lower pressures. The result is both the efficient refilling of the gaseous hydrogen storage tanks and the efficient dispensing of gaseous hydrogen to hydrogen vehicles.

### BRIEF DESCRIPTION OF THE FIGURES

The description is presented with reference to the accompanying figures in which:

FIG. 1 depicts one embodiment of the methods of the present invention for filling gaseous hydrogen storage tanks at a hydrogen energy station.

### DETAILED DESCRIPTION OF THE INVENTION

The present invention discloses methods for filling gaseous hydrogen storage tanks. The present invention includes methods for refilling gaseous hydrogen storage tanks utilizing a cascade fill. The methods of the present invention provide for the efficient refilling of the gaseous hydrogen storage tanks and the efficient dispensing of gaseous hydrogen to hydrogen vehicles.

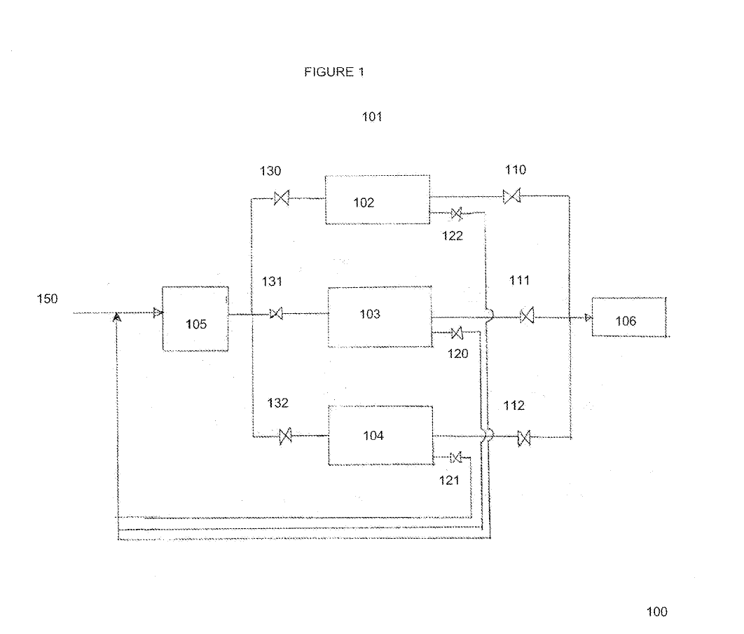

With reference to FIG. 1, FIG. 1 depicts one embodiment of the methods of the present invention for filling gaseous hydrogen storage tanks. FIG. 1 depicts a hydrogen energy station 100 for generating, storing, and dispensing gaseous hydrogen for use by hydrogen vehicles or other devices requiring hydrogen rich feed streams. First, the gaseous hydrogen is generated by a fuel processor 150 (not illustrated) at the hydrogen station 100. A fuel processor is generally an apparatus for converting a hydrocarbon fuel into a hydrogen rich gas. The gaseous hydrogen is then stored in a cascade storage system 101 via the hydrogen storage compressor 105.

In another embodiment, the gaseous hydrogen may be generated off-site and transported to the hydrogen energy station 100 and stored in a cascade storage system 101.

Hydrogen vehicles or other devices requiring hydrogen rich feed streams may visit the hydrogen energy station 100 to obtain gaseous hydrogen. The gaseous hydrogen is then dispensed to the vehicle tank 106 of the hydrogen vehicle or other device requiring a hydrogen rich feed stream.

The cascade storage system 101 includes a plurality of gaseous hydrogen storage tank. In FIG. 1, one embodiment of the cascade storage system 101 includes three gaseous hydrogen storage tanks—the first gaseous hydrogen storage tank 102, the second gaseous hydrogen storage tank 103, and the third gaseous hydrogen storage tank 104. In addition, the cascade storage system 101 includes the previously mentioned hydrogen storage compressor 105 and a plurality of valves.

The first valve 130 controls the flow of gaseous hydrogen to the first gaseous hydrogen storage tank 102 via the hydrogen storage compressor 105. The third valve 131 controls the flow of gaseous hydrogen to the second gaseous hydrogen storage tank 103 via the hydrogen storage compressor 105. The fifth valve 132 controls the flow of gaseous hydrogen to the third gaseous hydrogen storage tank 104 via the hydrogen storage compressor 105.

The second valve 110 controls the flow of gaseous hydrogen from the first gaseous hydrogen storage tank 102 to the vehicle tank of a hydrogen vehicle 106. The fourth valve 111 controls the flow of gaseous hydrogen from the second gaseous hydrogen storage tank 103 to the vehicle tank of a hydrogen vehicle 106. The sixth valve 112 controls the flow of gaseous hydrogen from the third gaseous hydrogen storage tank 104 to the vehicle tank of a hydrogen vehicle 106.

The first refilling valve 122 controls the flow of gaseous hydrogen from the first gaseous hydrogen storage tank 102 to the hydrogen storage compressor 105. The second refilling valve 120 controls the flow of gaseous hydrogen from the second gaseous hydrogen storage tank 103 to the hydrogen storage compressor 105. The third refilling valve 121 controls the flow of gaseous hydrogen from the third gaseous hydrogen storage tank 104 to the hydrogen storage compressor 105.

Typically in a cascade storage system 101, the filling and refilling of the first, second, and third gaseous hydrogen storage tanks 102, 103, 104 respectively may be conducted in sequence or in parallel. The first, second, and third gaseous hydrogen storage tanks 102, 103, 104 respectively are typically different sizes. For example, the first, second, and third gaseous hydrogen storage tanks 102, 103, 104 respectively may have a size ratio of 3:2:1 respectively.

The cascade storage system 101 is both a power intensive and a time consuming process. Typically, a cascade storage system 101 requires the compression of gaseous hydrogen via the hydrogen storage compressor 105 from 200 psig (the typical operating pressure of the pressure swing adsorption unit of the fuel processor 150) up to at least 5000 psig (the typical pressure of the gaseous hydrogen storage tank). As described below, in the present invention, the pressure ratio requirement is reduced by both using the residual hydrogen in the gaseous hydrogen storage tanks and equalizing the pressure in the gaseous hydrogen storage tanks in conjunction with the hydrogen storage compressor 105.

When a hydrogen vehicle needs to be fueled with gaseous hydrogen, the second valve 110 of the cascade storage system 101 is opened. When the second valve 110 is opened, the pressure of the first gaseous hydrogen storage tank 102 and the pressure of the vehicle tank 106 equalize. For example, if the vehicle tank 106 was at a pressure of 200 psig and the first gaseous hydrogen storage tank 102 was at a pressure of 6000 psig, when the second valve 110 is opened the pressure in the first gaseous hydrogen storage tank 102 will decrease as pressure in the vehicle tank 106 increases. The flow of gaseous hydrogen from the first gaseous hydrogen storage tank 102 to the vehicle tank 106 will stop when the first hydrogen storage tank 102 and the vehicle tank 106 equalize in pressure.

Once the first hydrogen storage tank 102 and the vehicle tank of the hydrogen vehicle 106 equalize in pressure, the second valve 110 is closed and the fourth valve 111 is opened. The opening of the fourth valve 111 allows the pressure of the second gaseous hydrogen storage tank 103 to equalize with the pressure of the vehicle tank 106 and allows gaseous hydrogen to flow from the second gaseous hydrogen storage tank 103 to the vehicle tank 106. The flow of gaseous hydrogen from the second gaseous hydrogen storage tank 103 to the vehicle tank 106 will stop when the second hydrogen storage tank 103 and the vehicle tank 106 equalize in pressure.

Once the second hydrogen storage tank 103 and the vehicle tank of the hydrogen vehicle 106 equalize in pressure, the fourth valve 111 is closed and the sixth valve 112 is opened. The opening of the sixth valve 112 allows the pressure of the third gaseous hydrogen storage tank 104 to equalize with the pressure of the vehicle tank 106 at the desired pressure of 5000 psig and allows gaseous hydrogen to flow from the second gaseous hydrogen storage tank 103 to the vehicle tank 106. The flow of gaseous hydrogen from the third gaseous hydrogen storage tank 104 to the vehicle tank 106 will stop when the third hydrogen storage tank 104 and the vehicle tank 106 reach the desired delivery pressure of 5000 psig (350 bar). At this point, fueling of the vehicle tank 106 will be complete.

After fueling of the vehicle tank 106 is complete, the gaseous hydrogen storage tanks need to be refilled back to their original capacity beginning with the first gaseous hydrogen storage tank 102. The residual gaseous hydrogen in the second gaseous hydrogen storage tank 103 and the third gaseous hydrogen storage tank 104 are at pressures greater than the residual hydrogen in the first gaseous hydrogen storage tank 102 since the second and third gaseous hydrogen storage tanks 103 and 104 respectively equalized with the vehicle tank 106 at a higher pressure. Therefore, the higher pressure gaseous hydrogen in the second and third gaseous hydrogen storage tanks 103 and 104 respectively can be utilized for filling the first gaseous hydrogen storage tank 102 via the hydrogen storage compressor 105, the second refilling valve 120, and the third refilling valve 121. This method both minimizes the intake of gaseous hydrogen from the fuel processor 150 and reduces the pressure ratio for compression. In another embodiment, the gaseous hydrogen for refilling may be generated off-site and transported to the hydrogen energy station 100 for refilling the gaseous hydrogen storage tanks.

In one embodiment, the third refilling valve 121 is opened to allow residual gaseous hydrogen at a higher pressure from the third gaseous hydrogen tank 104 to flow to the first gaseous hydrogen storage tank 102 via the hydrogen storage compressor 105 and the first valve 130. If the first gaseous hydrogen storage tank 102 is at capacity following receipt of residual gaseous hydrogen at a higher pressure from the third gaseous hydrogen storage tank 104, the first valve 130 is closed. Next, the third valve 131 is opened to allow residual gaseous hydrogen at a higher pressure from the third gaseous hydrogen tank 104 to flow to the second gaseous hydrogen storage tank 103 via the hydrogen storage compressor 105 and the third valve 131. If the second gaseous hydrogen storage tank 103 is at capacity following receipt of residual gaseous hydrogen at a higher pressure from the third gaseous hydrogen storage tank 104, the third valve 131 and the third refilling valve 121 are closed. Next, the fifth valve 132 is opened and gaseous hydrogen from the fuel processor 150 is used to fill the third gaseous hydrogen storage tank 104 via the hydrogen storage compressor 105.

In another embodiment, the third refilling valve 121 is opened to allow residual gaseous hydrogen at a higher pressure from the third gaseous hydrogen tank 104 to flow to the first gaseous hydrogen storage tank 102 via the hydrogen storage compressor 105 and the first valve 130. If the first gaseous hydrogen storage tank 102 is not at capacity following receipt of residual gaseous hydrogen at a higher pressure from the third gaseous hydrogen storage tank 104, the third refilling valve 121 is closed and the second refilling valve 120 is opened to allow residual gaseous hydrogen at a higher pressure from the second gaseous hydrogen tank 103 to flow to the first gaseous hydrogen storage tank 102 via the hydrogen storage compressor 105 and the first valve 130. If the first gaseous hydrogen storage tank 102 is at capacity following receipt of residual gaseous hydrogen at a higher pressure from the second gaseous hydrogen storage tank 103, the first valve 130 and the second refilling valve 120 are closed. Next, the third valve 132 is opened and gaseous hydrogen from the fuel processor 150 is used to fill the second gaseous hydrogen storage tank 103 via the hydrogen storage compressor 105. Finally, when the second gaseous hydrogen storage tank is at capacity, the third valve 131 is closed and the fifth valve 132 is opened and gaseous hydrogen from the fuel processor 150 is used to fill the third gaseous hydrogen storage tank 104 via the hydrogen storage compressor 105.

In another embodiment, the third refilling valve 121 is opened to allow residual gaseous hydrogen at a higher pressure from the third gaseous hydrogen tank 104 to flow to the first gaseous hydrogen storage tank 102 via the hydrogen storage compressor 105 and the first valve 130. If the first gaseous hydrogen storage tank 102 is not at capacity following receipt of residual gaseous hydrogen at a higher pressure from the third gaseous hydrogen storage tank 104, the third refilling valve 121 is closed and the second refilling valve 120 is opened to allow residual gaseous hydrogen at a higher pressure from the second gaseous hydrogen tank 103 to flow to the first gaseous hydrogen storage tank 102 via the hydrogen storage compressor 105 and the first valve 130. If the first gaseous hydrogen storage tank 102 is not at capacity following receipt of residual gaseous hydrogen at a higher pressure from the second gaseous hydrogen storage tank 103, the second refilling valve 120 is closed and the first valve 130 is opened and gaseous hydrogen from the fuel processor 150 is used to fill the first gaseous hydrogen storage tanks 102 via the hydrogen storage compressor 105. Next, when the first gaseous hydrogen storage tank 102 is at capacity, the first valve 130 is closed and the third valve 131 is opened and gaseous hydrogen from the fuel processor 150 is used to fill the second gaseous hydrogen storage tank 103 via the hydrogen storage compressor 105. Finally, when the second gaseous hydrogen storage tank is at capacity, the third valve 131 is closed and the fifth valve 132 is opened and gaseous hydrogen from the fuel processor 150 is used to fill the third gaseous hydrogen storage tank 104 via the hydrogen storage compressor 105.

While the methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A hydrogen cascade storage method comprising:
fueling a vehicle tank of a hydrogen vehicle with gaseous hydrogen from a cascade storage system comprising a plurality of gaseous hydrogen storage tanks;
refilling said plurality of gaseous hydrogen storage tanks with residual gaseous hydrogen contained within said plurality of gaseous hydrogen storage tanks via a compressor beginning with highest pressure gaseous hydrogen storage tank refilling lowest pressure gaseous hydrogen storage tank; and
introducing additional gaseous hydrogen to said cascade storage system to refill said plurality of gaseous hydrogen storage tanks.

2. The method of claim 1 wherein said plurality of gaseous hydrogen storage tanks comprises a first gaseous hydrogen storage tank, a second gaseous hydrogen storage tank, and a third gaseous hydrogen storage tank.

3. The method of claim 2 wherein said highest pressure gaseous storage tank is said third gaseous hydrogen storage tank and wherein said lowest pressure gaseous hydrogen storage tank is said first gaseous hydrogen storage tank.

4. The method of claim 2 wherein size ratio of said first gaseous hydrogen storage tank, said second gaseous hydrogen storage tank, and said third gaseous hydrogen storage tank is 3:2:1.

5. The method of claim 4 wherein fueling of said vehicle tank with said gaseous hydrogen from said plurality of gaseous hydrogen storage tanks begins with said first gaseous hydrogen storage tank, then proceeds to said second gaseous hydrogen storage tank, and concludes with said third gaseous hydrogen storage tank.

6. The method of claim 5 wherein after fueling said vehicle tank with said gaseous hydrogen pressure of said third gaseous hydrogen storage tank is greater than pressure of said second gaseous hydrogen storage tank and pressure of said second gaseous storage tank is greater than pressure of said first gaseous hydrogen storage tank.

7. The method of claim 6 wherein refilling said plurality of gaseous hydrogen storage tanks with said residual gaseous hydrogen contained within said plurality of gaseous hydrogen storage tanks begins with said third gaseous hydrogen storage tank refilling said first gaseous hydrogen storage tank.

8. The method of claim 7 wherein said additional gaseous hydrogen is used to refill said first, second, and/or third gaseous hydrogen storage tanks.

9. The method of claim 7 further comprising said third gaseous hydrogen storage tank refilling said second gaseous hydrogen storage tank.

10. The method of claim 9 wherein said additional gaseous hydrogen is used to refill said first, second, and/or third gaseous hydrogen storage tanks.

11. The method of claim 1 wherein pressure of vehicle tank after fueling is 5000 psig.

12. The method of claim 1 wherein said additional gaseous hydrogen is generated onsite.

13. The method of claim 1 wherein said additional gaseous hydrogen is transported from offsite.
